(19) United States
(12) Patent Application Publication
(10) Pub. No.: US 2017/0210493 A1
(43) Pub. Date: Jul. 27, 2017

(54) SPACECRAFT PROPULSION SYSTEM AND METHOD

(71) Applicant: SAFRAN AIRCRAFT ENGINES, Paris (FR)

(72) Inventor: Frederic MARCHANDISE, Vernon (FR)

(73) Assignee: SAFRAN AIRCRAFT ENGINES, Paris (FR)

(21) Appl. No.: 15/329,470

(22) PCT Filed: Jul. 27, 2015
(86) PCT No.: PCT/FR2015/052067

§ 371 Date: Jan. 26, 2017

(30) Foreign Application Priority Data
Jul. 30, 2014 (FR) 1457371

(51) Int. Cl. B64G 1/40; B64G 1/26; F03H 1/00; B64G 1/44

(52) U.S. Cl. CPC B64G 1/406; B64G 1/443; B64G 1/26; B64G 1/405; F03H 1/0075; F03H 1/0012; F03H 1/0018

(57) ABSTRACT

A space propulsion system includes an electrostatic thruster with a first electrical load; a resistojet; a propellant fluid feed circuit; and an electrical power supply circuit including a first power supply line and a first switch for selecting between connecting the first power supply line to the resistojet and connecting the first power supply line to the first electrical load of the electrostatic thruster. The propulsion system thus enables a space propulsion method to be applied that includes a switching step for selecting a first propulsion mode in which the resistojet is activated, or a second propulsion mode in which the electrostatic thruster is activated.

### BACKGROUND OF THE INVENTION

The present invention relates to the field of space propulsion.

In this field, electric thrusters are becoming more and more frequent, in particular for controlling the attitude and the orbit of spacecraft. Specifically, the various types of electric thruster available provide specific impulse that is generally greater than that of conventional chemical or cold gas thrusters, thus making it possible to reduce the consumption of propellant fluid for the same maneuvers, thereby increasing the lifetime and/or the payload of spacecraft.

Among the various types of electric thruster, two categories are known in particular: so-called thermoelectric thrusters in which the propellant fluid is heated electrically prior to expanding in a thrust nozzle, and so-called electrostatic thrusters in which the propellant fluid is ionized and accelerated directly by an electric field. Among thermoelectric thrusters, there are in particular those known as “resistojets”, in which heat is transmitted to the propellant fluid by at least one resistor heated by the Joule effect. Furthermore, among electrostatic thrusters, there are in particular so-called “Hall effect” thrusters. In such thrusters, also known as close electron drift plasma engines or as stationary plasma engines, electrons emitted by an emitter cathode are captured by a magnetic field generated by coils situated around and in the center of a discharge channel of annular section, thus forming a virtual cathode grid at the end of the discharge channel. The propellant fluid (typically xenon in the gaseous state) is injected into the end of the discharge channel and electrons escaping from the virtual cathode grid towards the anode situated at the end of the discharge channel impact molecules of the propellant fluid, thereby ionizing it, so that it is consequently accelerated towards the virtual cathode grid by the electric field that exists between the grid and the cathode, prior to being neutralized by other electrons emitted by the emitter cathode. Typically, in order to ensure that electrons are emitted from the cathode, the cathode is heated electrically.

Furthermore, Hall effect thrusters are not the only thrusters that include similar emitter cathodes. Another example of an electrostatic thruster with an analogous cathode is the high efficiency multistage plasma thruster (HEMP) as described for example by H.-P. Harmann, N. Koch, and G. Kornfeld in “Low complexity and low cost electric propulsion system for telecom satellites based on HEMP thruster assembly”, IEPC-2007-114, 30th International Electric Propulsion Conference, Florence, Italy, Sep. 17-20, 2007. In such a HEMP thruster, the ionized propellant fluid is accelerated by an electric field formed between an anode and a plurality of virtual cathode grids formed by electrons trapped in the magnetic fields of a plurality of permanent magnets. In general, all electrostatic thrusters include an emitter cathode, at least for neutralizing the propellant fluid downstream from the thruster.

Electrostatic thrusters make it possible to obtain specific impulses that are particularly high compared with other types of thruster, including thermoelectric thrusters. In contrast, their thrust is very low. Space propulsion systems have thus been proposed combining electrostatic thrusters for slow maneuvers, such as for example maintaining orbit or desaturating reaction wheels, and thrusters of other types for maneuvers that require greater thrust. Thus, M. De Tata, P.-E. Frigot, S. Beekmans, H. Lübberstedt, D. Birreck, A. Demairé, and P. Rathsman in “SGEO development status and opportunities for the EP-based small European telecommunications platform”, IEPC-2011-203, 32^{nd} International Electric Propulsion Conference, Wiesbaden, Germany, Sep. 11-15, 2011, and S. Naclerio, J. Soto Salvador, E. Such, R. Avenzuela, and R. Perez Vara in “Small GEO xenon propellant supply assembly pressure regulator panel: test results and comparison with ECOSIMPRO predictions”, SP2012-2355255, 3^{rd} International Conference on Space Propulsion, Bordeaux, May 7-10, 2012, describe a space propulsion system for small geostationary satellites, comprising both electrostatic thrusters and cold gas thrusters fed by a common propellant fluid feed circuit. Nevertheless, since the specific impulse of cold gas thrusters is very limited, they consume a large amount of propellant fluid for high-thrust maneuvers, and in addition, in that system, there is little sharing of resources between the various types of thruster, resulting in the system being rather complex.

### OBJECT AND SUMMARY OF THE INVENTION

The present invention seeks to remedy those drawbacks. In particular, this disclosure seeks to propose a space propulsion system that makes it possible to offer at least a first propulsion mode with high specific impulse and low thrust, and a second propulsion mode with higher thrust but lower specific impulse than the first propulsion mode, but with specific impulse that is nevertheless greater than that which can be supplied by cold gas thrusters, and to do so with an electrical power supply circuit that is relatively simple.

In at least one embodiment, this object is achieved by the fact that the propulsion system comprises an electrostatic thruster with at least a first electrical load; a resistojet; a propellant fluid feed circuit; and an electrical power supply circuit comprising at least a first power supply line and a first switch for selecting between connecting said first power supply line to the resistojet and connecting said first power supply line to said first electrical load of the electrostatic thruster. The use of a resistojet makes it possible to obtain specific impulse that is greater than that of cold gas thrusters, while continuing to share at least some of the propellant fluid feed circuits for feeding propellant fluid both to the electrostatic thruster and to the resistojet. Simultaneously, the first switch makes it possible to power the resistojet electrically from the same power supply line that can alternatively be used for powering a first electrical load of the electrostatic thruster, thereby simplifying the power supply circuit.

In particular, said first electrical load of the electrostatic thruster may comprise a heater element for heating an emitter cathode of said electrostatic thruster. The heater elements of such emitter cathodes and the heater elements of the resistojet may be constituted by resistors, and said first switch may serve to select between connecting said first power supply line, without any current or voltage conversion or transformation, to a resistor forming a heater element of the resistojet, and connecting said first power supply line, without any current or voltage conversion or transformation, to a resistor forming the heater element of the emitter cathode of said electrostatic thruster.

In order to control the propellant fluid fed to the electrostatic thruster and to the resistojet, said propellant fluid feed circuit includes at least one valve for feeding the electrostatic thruster and at least one valve for feeding the resistojet. In particular, the propulsion system may further comprise at least one valve-opening control line and a second switch for selecting between connecting said valve-opening control line to the valve for feeding the electrostatic thruster, and connecting said valve-opening control line to at least one feed valve of the resistojet. Depending on the selected propulsion mode, a single valve-opening control line can thus be used in alternation to control the feed of propellant fluid either to the electrostatic thruster or to the resistojet, thereby simplifying valve control.

Typically, in electrostatic thrusters, a particularly high voltage needs to be established between a cathode and an anode in order to generate an electric field for accelerating the ionized propellant fluid. This voltage is normally significantly higher than the power supply voltage for heating the emitter cathode, or the voltage supplied by the sources of electricity on board a spacecraft, such as photovoltaic panels, batteries, fuel cells, or thermoelectric generators. In order to provide this high voltage as well, said power supply circuit may further include at least one power processing unit suitable for powering at least one other electrical load of the electrostatic thruster at a voltage that is considerably higher than the first electrical load. The first power supply line may be integrated at least in part in said power processing unit, although it could alternatively bypass the power processing unit and be connected directly to a distribution busbar of an electricity network of the spacecraft or to on-board power supplies.

Said power supply circuit may comprise at least one thruster selection unit in which at least said first switch is integrated. Thus, if a plurality of connections need to be switched simultaneously for selecting one thruster or the other, all of the corresponding switches may optionally be incorporated in such a thruster selection unit, and may be controlled by the same control signal.

Said electrostatic thruster may in particular be a Hall effect thruster. Specifically, Hall effect thrusters have already abundantly demonstrated their reliability in space propulsion. Nevertheless, other types of electrostatic thruster may also be envisaged, and in particular HEMP thrusters.

In particular in order to provide thrust along a plurality of different axes, the space propulsion system may have a plurality of electrostatic thrusters. Under such circumstances, in order to simplify feeding propellant gas to the assembly, the propellant fluid feed circuit may include at least one pressure regulator device that is common to a plurality of said electrostatic thrusters. Nevertheless, in addition, or as an alternative to at least one pressure regulator device common to a plurality of said electrostatic thrusters, said propellant fluid feed circuit may have an individual pressure regulator device for at least one of said electrostatic thrusters.

The present disclosure also relates to an attitude and/or trajectory control system including such a space propulsion system, to a spacecraft, e.g. such as a satellite or a probe, including such a space propulsion system, and also to a space propulsion method including a step of switching between an electrostatic thruster and a resistojet, wherein a first switch is used for connecting a first electrical power supply line to the resistojet or to a low voltage first electrical load of the electrostatic thruster in order to select a first propulsion mode in which the resistojet is activated or else a second propulsion mode in which the electrostatic thruster is activated.

### BRIEF DESCRIPTION OF THE DRAWINGS

The invention can be well understood and its advantages appear better on reading the following detailed description of embodiments given as non-limiting examples. The description refers to the accompanying drawings, in which:

FIG. 1 is a diagrammatic view of a spacecraft fitted with an attitude and trajectory control system including a space propulsion system in accordance with any of the embodiments;

FIG. 2A is a detail diagram showing a space propulsion system in a first embodiment with switches in position for selecting an electrostatic thruster;

FIG. 2B is a detail diagram showing the FIG. 2B system with the same switches in position for selecting a resistojet;

FIG. 3 is a detail diagram showing a space propulsion system in a second embodiment;

FIG. 4 is a detail diagram showing a space propulsion system in a third embodiment; and

FIG. 5 is a detail diagram showing a space propulsion system in a fourth embodiment.

### DETAILED DESCRIPTION OF THE INVENTION

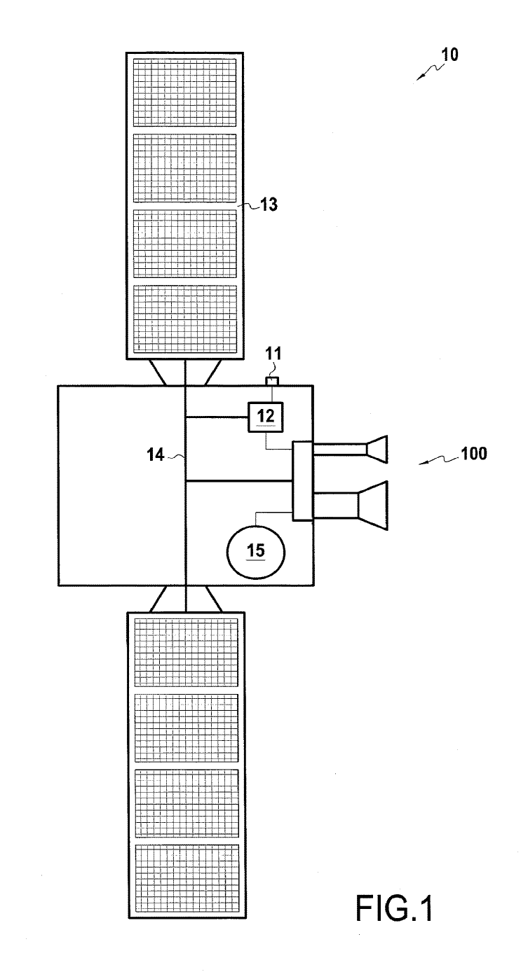

FIG. 1 shows a spacecraft 10, more specifically a satellite, fitted with an attitude and trajectory control system for maintaining the orbit and the attitude of the spacecraft relative to the body it is orbiting. For this purpose, the attitude and trajectory control system comprises not only at least one sensor 11 for determining the real attitude and trajectory of the spacecraft, and a control unit 12 connected to the sensor 11 and serving to determine the desired attitude and trajectory together with the maneuvers that need to be performed in order to reach the desired attitude and trajectory from the real attitude and trajectory as determined by the at least one sensor 11, but also maneuvering means connected to the control unit 12, and capable of exerting forces and torque on the spacecraft 10 in order to perform said maneuvers. In the example shown, the maneuvering means comprise in particular a space propulsion system 100, although other maneuvering means such as inertial devices, e.g. reaction wheels, or devices using the pressure of solar radiation, could be envisaged in addition to this space propulsion system 100.

Furthermore, the spacecraft 10 also has an electrical power supply 13, in the form of photovoltaic panels in the example shown, although other electrical power supplies such as batteries, fuel cells, or thermoelectric generators could equally well be envisaged in addition to or instead of these photovoltaic panels. This electrical power supply 13 is connected to the various electrical loads in the spacecraft by a main power supply bus 14.

In addition, the spacecraft 10 also has at least one tank 15 of propellant fluid, such as xenon, for example.

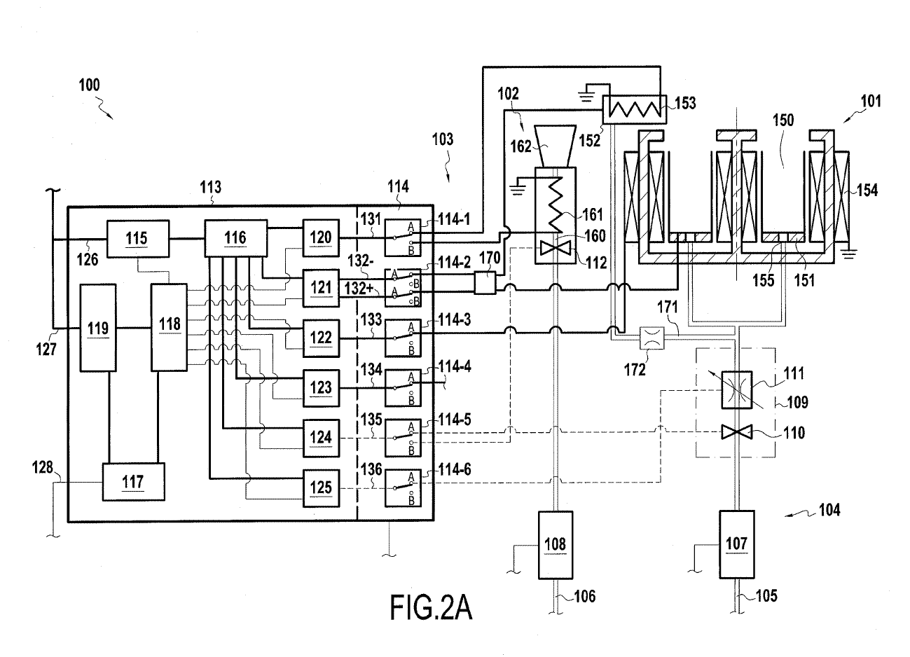

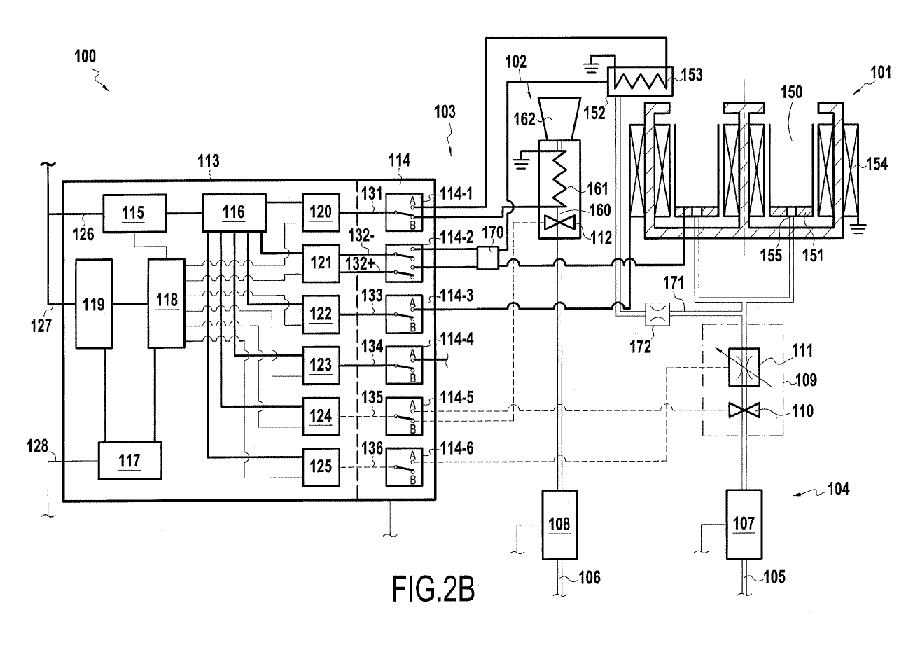

FIGS. 2A and 2B show a space propulsion system 100 in a first embodiment. The space propulsion system 100 comprises an electrostatic thruster 101 and a resistojet 102. In addition, it also has an electrical power supply circuit 103 and a propellant fluid feed circuit 104, both connected to both thrusters in order to supply them respectively with electricity and propellant fluid. The electrical power supply circuit 103 is connected to the electrical power supply 13 of the spacecraft 10 via the bus 14. The propellant fluid feed circuit 104 is connected to the tank 15.

The electrostatic thruster 101, which is more specifically a Hall effect thruster, comprises a channel 150 of annular section that is closed at its upstream end and open at its downstream end, an anode 151 situated at the upstream end of the channel 150, an emitter cathode 152 situated downstream from the downstream end of the channel 150 and fitted with at least one heater element 153, electromagnets 154 situated radially inside and outside the channel 150, and propellant fluid injectors 155 situated at the upstream end of the channel 150.

The resistojet 102 is simpler, mainly comprising at least one propellant fluid injector 160, a heater element 161, and a nozzle 162.

As can also be seen in FIGS. 2A and 2B, the propellant fluid feed circuit 104 comprises a line 105 for feeding propellant fluid to the electrostatic thruster 101, which line is connected to the injectors 155 of the electrostatic thruster 101, and a line 106 for feeding propellant fluid to the resistojet 102, which line is connected to the injector 162 of the resistojet 102. The line 105 has a regulator 107 installed thereon for regulating the pressure at which the electrostatic thruster 101 is fed with propellant gas, and the line 106 has a regulator 108 installed therein for regulating the feed pressure to the resistojet 102. These pressure regulators 107 and 108 thus serve to ensure substantially constant feed pressures for both thrusters, even when the pressure in the tank 15 varies considerably. Although the embodiment shown has two different pressure regulators for obtaining different feed pressures, it would also be possible to envisage using a single common pressure regulator for supplying the same pressure to both thrusters.

A flow rate regulator 109 is also installed in the line 105 for feeding propellant gas to the electrostatic thruster 101, downstream from the pressure regulator 107 but still upstream from the injectors 155 for injecting propellant fluid into the electrostatic thruster 101.

The flow rate regulator 109 has an on/off valve 110 and a thermal throttle 111 connected in series respectively for controlling the feed of propellant gas to the electrostatic thruster 101 and for regulating its flow rate. Furthermore, the propellant fluid feed circuit 104 also has a branch connection 171 connecting the line 105 downstream from the flow rate regulator 109 to the cathode 152 in order to deliver a very small flow rate of gas to the cathode 152, which is a hollow cathode, so as to facilitate emitting electrons from the cathode 152, and also so as to cool it. A constriction 172 in this branch connection 171 restricts the flow rate of propellant gas supplied to the cathode compared with the flow rate that is injected through the injectors 155.

The propellant fluid feed circuit 104 also has a valve 112 for feeding propellant gas to the resistojet 102, which valve is directly incorporated in the resistojet 102 upstream from the injector 160 in the embodiment shown, although it could equally well be installed in the line 106, between the pressure regulator 108 and the resistojet 102.

The electrical power supply circuit 103 comprises a power processing unit (PPU) 113 having a thruster selection unit (TSU) 114. Although the selection unit 114 in the embodiment shown is integrated in the processing unit 113, it is also possible to envisage arranging it on the outside thereof. Under such circumstances, it may be referred to as an external thruster selection unit (ETSU).

The power processing unit 113 also has a limiter 115, inverters 116, a control interface 117, a sequencer 118, and a DC voltage converter 119.

Furthermore, the power processing unit 113 also has a regulator 120 for regulating the current I_{H} that is fed to the heater element, a regulator 121 for regulating the voltages V_{D}⁺ and V_{D}⁻, and the current I_{D} fed to the anode 151 and to the cathode 152, a regulator 122 for regulating the current I_{M} fed to the electromagnet, regulators 123 for regulating electrical ignition pulses, a regulator 124 for valve control, and a regulator 125 for controlling the control current I_{TT} of the thermal throttle. For their electrical power supply, these regulators 120 to 125 are all connected to a first power supply input 126 of the processing unit 113 via the inverters 116. The control interface 117 and the sequencer 118 are connected to a second power supply input 127 of the processing unit 113 via the converter 119 for their own power supplies, and via a control input 128 to the control unit 12 of the attitude and trajectory control system. They are also connected to the regulators 120 to 125 so as to control their operation.

The selection unit 114 comprises a set of switches, each connected to one of the outputs from the regulators 120 to 125 via a corresponding power supply or control line. Thus, the regulator 120 is connected to the switch 114-1 by a first power supply line 131, the regulator 121 to the double-pole switch 114-2 by second and third power supply lines 132+ and 132−, the regulator 122 to the switch 114-3 by a fourth power supply line 133, the regulator 123 to the switch 114-4 by a fifth power supply line 134, the regulator 124 to the switch 114-5 by a line 135 for controlling valve opening, and the regulator 125 to the switch 114-6 by a thermal throttle control line 136. Each switch can switch between at least one first contact A and at least one second contact B, and the selection unit 114 is connected to the control unit 12 so as to enable it to cause all of the switches to switch simultaneously.

In the embodiment shown, each contact A of the switches 114-1 to 114-4 in a first group is connected to a electrical load of the electrostatic thruster 101. Thus, the contact A of the switch 114-1 is connected to the heater element 153 of the emitter electrode 152, and the contact A of the switches 114-3 to 114-4 are connected respectively to the electromagnets 154 and to the ignition means (not shown) of the electrostatic thruster 101. In the embodiment shown, each of these electrical loads is connected to ground, so that a single switch and a single go power supply line serve to power each of them. Nevertheless, it is also possible to envisage isolating each of these electric switches and to avoid grounding by using return lines and double-pole switches connected not only to the go lines but also to the return lines in order to switch them on or off. Thus, in the embodiment shown, one of the contacts A of the double-pole switch 114-2 is connected to the cathode 152 via a filter device 170 and may be connected by the switch 114-2 to the power supply line 132− of negative polarity, and the other contact A of the double-pole switch 114-2 is connected to the anode 151 via the same filter device 170 and may be connected by the switch 114-2 to the power supply line 132+ of positive polarity. In addition, each contact A of the switches 114-5 and 114-6 of a second group is connected to the flow rate regulator 109 of the line 105 for feeding propellant fluid to the electrostatic thruster 101. In particular, the contact A of the switch 114-5 is connected to the valve 110, while the contact A of the switch 114-6 is connected to the thermal throttle 111.

Furthermore, in the embodiment shown, the contact B of the switch 114-1 and the contact B of the switch 114-5 are respectively connected to the heater elements 161 and to the valve 112 of the resistojet 102.

Thus, in operation, the power processing unit 113 can power electrically and cause propellant fluid to be fed either to the electrostatic thruster 101 or to the resistojet 102, depending on a selection performed via the thruster selection unit 114. In this way, when the switches 114-1 to 114-6 connect the power supply lines 131, 132+, 132−, 133, and 134 to the electrostatic thruster 101 and the control lines 135 and 136 to the flow rate regulator 109, as shown in FIG. 2A, the electrostatic thruster 101 can be activated and controlled by the control unit 12 of the spacecraft 10 via the power processing unit 113. In particular, signals coming from the control unit 12 are transmitted to the regulators 120 to 125 via the control interface 117 and the sequencer 118, serving under such circumstances firstly to supply power to the various electrical loads of the electrostatic thruster 101 via the regulators 120 to 123, and secondly to act via the regulators 124 and 125 to feed propellant fluid to the electrostatic thruster 101 via the flow rate regulator 109.

In contrast, when the switches 114-1 to 114-6 switch to their contacts B, as shown in FIG. 2B, the first power supply line 131 is connected to the heater element 161 of the resistojet 102, while the line 135 for controlling valve opening is connected to the valve 112 of the resistojet 102. In this way, signals coming from the control unit 12 and transmitted to the regulators 120 and 124 via the control interface 117 and the sequencer 118 then serve firstly to control electrical power supply to the heater element 161 of the resistojet 102 via the regulator 120 and secondly, acting via the regulator 124 to control the supply of propellant fluid to the resistojet 102 via the valve 112.

The space propulsion system 100 in this first embodiment can thus operate in a first propulsion mode with high specific impulse but low thrust, by selecting the electrostatic thruster 101 via the selection unit 114, or else in a second propulsion mode, with lower specific impulse, by selecting the resistojet 102 via the selection unit 114.

Although fluid feed to the electrostatic thruster 101 in this first embodiment takes place via a pressure regulator and a flow rate regulator comprising a valve and a thermal throttle, in other embodiments, the fluid may be fed to the electrostatic thruster via a unit for combined pressure and flow rate regulation comprising two on/off valves arranged in series. Because of the impedance of the propellant fluid feed circuit, in particular between the two on/off valves, it is possible to regulate both the pressure and the flow rate of the propellant fluid supplied to the electrostatic thruster by controlling the application of pulses to the two on/off valves. The pressure of the propellant fluid supplied to the resistojet may likewise be controlled in the same manner.

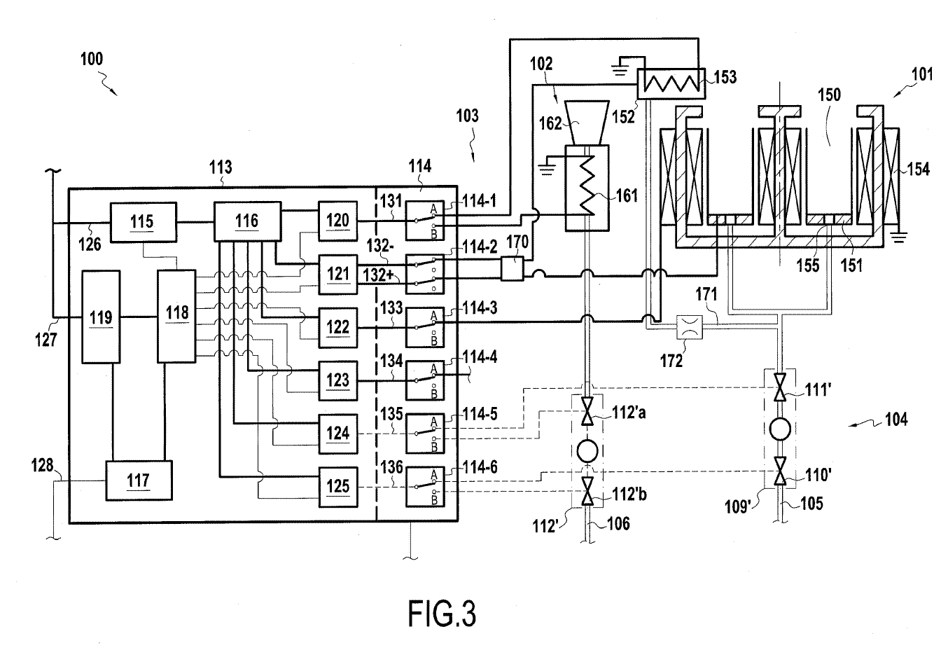

Thus, in a second embodiment as shown in FIG. 3, the pressure and flow rate regulators on the first gaseous fluid feed line of the propulsion system in the first embodiment may be replaced by a single pressure and flow rate regulator 109′ comprising two on/off valves 110′ and 111′ connected in series on the line 105 for feeding propellant gas to the electrostatic thruster 101. In this second embodiment, the valve of the resistojet and the corresponding pressure regulator are likewise replaced by a single pressure and flow rate regulator 112′ also comprising two on/off valves 112′a and 112′b connected in series on the line 106 for feeding propellant fluid to the resistojet 102. In the power processing unit 113, the regulator regulating the control current I_{TT} of the thermal throttle of the first embodiment is replaced by a second regulator 125′ for controlling opening of the valve. The other elements of the system in this second embodiment are analogous to those of the first embodiment and consequently receive the same reference numbers in FIG. 3 as in FIGS. 2A and 2B.

Thus, during operation of the space propulsion system 100 in this second embodiment, when the electrostatic thruster 101 is selected by the thruster selection unit 114 and its switches 114-1 to 114-6, signals coming from the control unit 12 and transmitted to the regulators 124 and 125 via the control interface 117 and the sequencer 118 control the valves 110′ and 111′ of the regulator 109′ in order to regulate the feed of propellant fluid to the electrostatic thruster 101. Furthermore, when the resistojet 102 is selected by the thruster selection unit 114 and its switches 114-1 to 114-6, the same signals can control the valves 112′a and 112′b of the regulator 112′ in order to regulate the feed of propellant fluid to the resistojet 102. Otherwise, the operation of the space propulsion system 100 in this second embodiment is analogous to that of the first embodiment, in particular concerning the regulation of the power supply to the electrostatic thruster 101 and to the resistojet 102, and the selection of the two different propulsion modes.

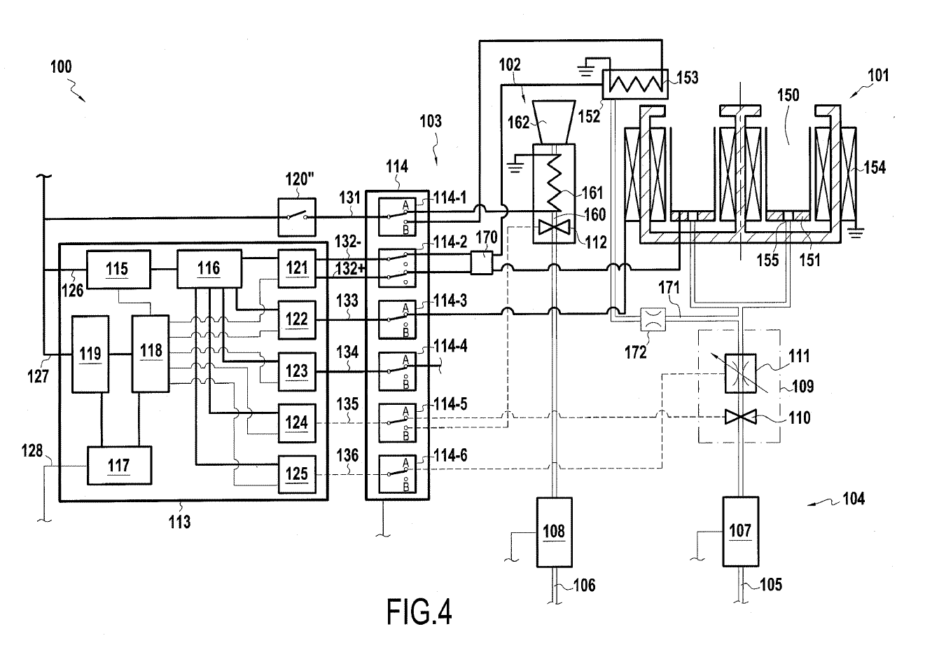

Although in the two above embodiments the power supply of the heater elements of the resistojet and of the emitter cathode of the electrostatic thruster, respectively, passes through the power processing unit, and in particular through one of the inverters, it is also possible envisage bypassing the power processing unit when powering these elements. The operating voltages on the heater elements of these two thrusters may be close to or even equal to the operating voltage of the main power supply bus, thus making it possible for them to be powered directly from the bus. Thus, in a third embodiment, shown in FIG. 4, the first power supply line 131 comes from a switch 120″ directly connected to the main power supply bus 14 and to the control unit 12 of the spacecraft 10. Although the switch 120″ in the embodiment shown is separate and distinct from the power processing unit 113, it is also possible to envisage integrating it therein. Furthermore, in the embodiment shown, the thruster selection unit 114 is also external to the power processing unit 113, even though it is possible to envisage integrating them. The other elements of the system in this third embodiment are nevertheless analogous to those of the first embodiment, and consequently they receive the same reference numbers in FIG. 4 as in FIGS. 2A and 2B.

In this way, during operation of the space propulsion system 100 in this third embodiment, when the electrostatic thruster 101 is selected by the thruster selection unit 114 and its switches 114-1 to 114-6, the signals transmitted by the control unit 12 to the switch 120″ can control current pulses on the first power supply line 131 for regulating the operation of the heater element 153 of the emitter cathode 152 of the electrostatic thruster 101. Furthermore, when the resistojet 102 is selected by the thruster selection unit 114 and its switches 114-1 to 114-6, the same pulses can regulate the operation of the heater element 161 of the resistojet 102. Otherwise, the operation of the space propulsion system 100 in this third embodiment is analogous to that of the first embodiment, in particular concerning regulating the feed of space propulsion system fluid to the electrostatic thruster 101 and to the resistojet 102, and selecting the two different propulsion modes.

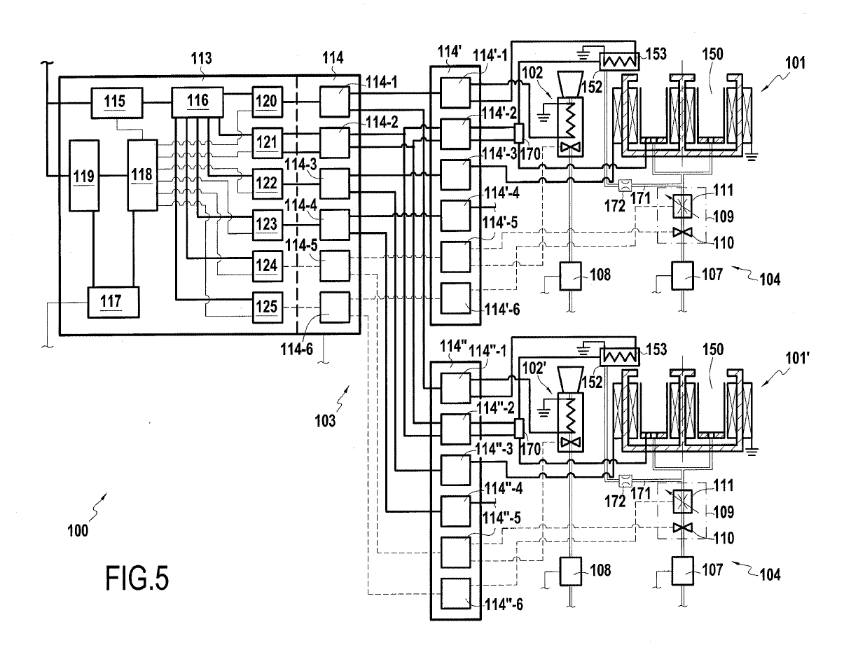

Although the space propulsion system in the three above-described embodiments has only one electrostatic thruster and only one resistojet, the same principles are equally applicable to systems having a plurality of electrostatic thrusters and of resistojets. Thus, in a fourth embodiment shown in FIG. 5, the space propulsion system 100 has two electrostatic thrusters 101 and two resistojets 102, e.g. arranged as thruster pairs, each pair being formed by one electrostatic thruster 101 and one resistojet 102, the thrusters in one of the pairs pointing in the opposite direction to the thrusters in the other pair. The two electrostatic thrusters 101 are connected to a single regulator 107 for regulating the pressure at which propellant gas is fed to the electrostatic thrusters 101 by corresponding propellant fluid feed lines 105, while the two resistojets 102 are likewise connected to a single regulator 108 for regulating the pressure at which propellant gas is fed to the resistojets 102 by other propellant fluid feed lines 106. In contrast, individual flow rate regulators 109 are installed on each of the propellant fluid feed lines 105 of the electrostatic thrusters 101 for separately regulating the propellant fluid low rate feed to each of the electrostatic thrusters 101. The propellant fluid feed circuit 104 also has a propellant gas feed valve 112 for each resistojet 102.

Furthermore, this space propulsion system 100 also has two external thruster selection units 114′ and 114″ in addition to the thruster selection unit 114 integrated in the power processing unit 113. The three thruster selection units 114, 114′, and 114″ are connected to the control unit 12 of the spacecraft 10 in order to control their respective switches 114-1 to 114-6, 114′-1 to 114′-6, and 114″-1 to 114″-6. The contacts A of the thruster selection unit 114 are connected to the electrostatic thruster 101 or to the resistojet 102 of a first one of said pairs of thrusters via the first external selection unit 114′, while the contacts B of the thruster selection unit 114 are connected to the electrostatic thruster 101 or to the resistojet 102 of the second one of said pairs of thrusters via the second external selection unit 114′. The other elements of the system in this fourth embodiment are analogous to those of the first embodiment and consequently they are given the same reference numbers in FIG. 5 as in FIGS. 2A and 2B.

Thus, in operation, the power processing unit 113 can power electrically and control the feed of propellant fluid either for a thruster of the first pair or else for a thruster of the second pair, depending on the selection performed by the propulsion selection unit 114. If the first pair of thrusters is selected by the selection unit 114, then selection between the electrostatic thruster 101 and the resistojet 102 of this first pair can be made by the first external selection unit 114′ in a manner analogous to selecting thrusters in the above-described embodiments. Likewise, if the second pair of thrusters is selected by the selection unit 114, selecting between the electrostatic thruster 101 and the resistojet 102 of this second pair may be performed by the second external selection unit 114″ in a manner analogous to selecting thrusters in the above-described embodiments. Thus, by means of the switches in the three selection units 114, 114′, and 114″, it is possible to select between two propulsion directions, and between two modes of propulsion in each direction. Otherwise, the operation of the space propulsion system 100 in this fourth embodiment is analogous to that of the first embodiment, in particular concerning regulating the supply of propellant fluid and of electricity to the thrusters.

Although the present invention is described with reference to a specific embodiment, it is clear that various modifications and changes may be made to these embodiments without going beyond the general ambit of the invention as defined by the claims. In addition, individual characteristics of the various embodiments mentioned may be combined in additional embodiments. In particular, the characteristics specific to the second and/or third embodiments could equally well be adapted to a system having a plurality of thruster selection units and of thrusters of each type, as in the fourth embodiment. Furthermore, although the system of the fourth embodiment has only two pairs of thrusters of different types, it is also possible to envisage incorporating a greater number of pairs therein. Consequently, the description and the drawings should be considered in a sense that is illustrative rather than restrictive.

1. A space propulsion system comprising:
an electrostatic thruster with at least a first electrical load;
a resistojet;
a propellant fluid feed circuit; and
an electrical power supply circuit comprising at least a first power supply line and a first switch for selecting between connecting said first power supply line to the resistojet and connecting said first power supply line to said first electrical load of the electrostatic thruster.

2. The space propulsion system according to claim 1, wherein said first electrical load comprises a heater element of an emitter cathode of said electrostatic thruster.

3. The space propulsion system according to claim 2, wherein said first switch serves to select between connecting said first power supply line, without any current or voltage conversion or transformation, to a resistor forming a heater element of the resistojet, and connecting said first power supply line, without any current or voltage conversion or transformation, to a resistor forming the heater element of the emitter cathode of said electrostatic thruster.

4. The space propulsion system according to claim 1, wherein said propellant fluid feed circuit includes at least one valve for feeding the electrostatic thruster and at least one valve for feeding the resistojet.

5. The space propulsion system according to claim 4, further comprising at least one valve-opening control line and a second switch for selecting between connecting said valve-opening control line to the valve for feeding the electrostatic thruster, and connecting said valve-opening control line to at least one feed valve of the resistojet.

6. The space propulsion system according to claim 1, wherein said power supply circuit comprises at least one thruster selection unit in which at least said first switch is integrated.

7. The space propulsion system according to claim 1, wherein said power supply circuit further includes at least one power processing unit suitable for powering at least one other electrical load of the electrostatic thruster at a voltage that is considerably higher than the first electrical load.

8. The space propulsion system according to claim 1, wherein said electrostatic thruster is a Hall effect thruster.

9. The space propulsion system according to claim 1, comprising a plurality of the electrostatic thruster.

10. The space propulsion system according to claim 9, wherein said propellant fluid feed circuit includes at least one pressure regulator common to the plurality of said electrostatic thruster.

11. The space propulsion system according to claim 9, wherein said propellant fluid feed circuit includes an individual pressure regulator for at least one of said plurality of said electrostatic thruster.

12. . An attitude and/or trajectory control system comprising:
the space propulsion system according to claim 1.

13. A spacecraft including comprising:
a space propulsion system according to claim 1.

14. A space propulsion method comprising:
switching between an electrostatic thruster and a resistojet, wherein a first switch is used for connecting a first electrical power supply line to the resistojet or to a first electrical load of the electrostatic thruster in order to select a first propulsion mode in which the resistojet is activated or else a second propulsion mode in which the electrostatic thruster is activated.
